(19) United States
(12) Patent Application Publication
(10) Pub. No.: US 2010/0186521 A1
(43) Pub. Date: Jul. 29, 2010

(54) METER WITH STANDARDISED CAPSULE-TYPE ULTRASOUND MEASURING CELL

(75) Inventor: Tarek Bouzid, Macon (FR)

Correspondence Address: DORITY & MANNING, P.A., POST OFFICE BOX 1449, GREENVILLE, SC, 29602-1449, US

(73) Assignee: ACTARIS S.A.S., Boulogne-Billancourt (FR)

(21) Appl. No.: 12/529,803

(22) PCT Filed: Feb. 29, 2008
(86) PCT No.: PCT/EP2008/052471

§ 371 Date: Mar. 19, 2010

(30) Foreign Application Priority Data
Mar. 6, 2007 (EP) 07300849.2

(51) Int. Cl. G01F 1/66

(52) U.S. Cl. 73/861.18

(57) ABSTRACT

The invention relates to a method of standardizing a capsule type ultrasound measurement cell (1) including a measurement channel (1A) equipped with ultrasound sensors (C1, C2) disposed in a cap (1G) and intended to be mounted on a tank including an inlet pipe and an outlet pipe of different types, said inlet pipe being intended to communicate with the inlet of said measurement channel and said outlet pipe being intended to communicate with the outlet of said measurement channel. According to the invention, this method consists in using an additional adapter (4, 5) specific to the type of tank and connecting said inlet pipe with the inlet of said measurement channel and said outlet pipe with the outlet of said measurement channel.

The invention relates to a meter with a capsule type ultrasound measurement cell.

To be more precise, it relates to a fluid meter, in particular a water meter, including a capsule type ultrasound measurement cell including a measurement channel equipped with ultrasound sensors and mounted on a tank including an inlet pipe and an outlet pipe, said inlet pipe communicating with the inlet of the measurement channel and said outlet pipe communicating with the outlet of the measurement channel.

Hereinabove and hereinafter, the expression capsule type measurement cell means a removable measurement cell that can be mounted on and demounted from a tank without intervening with the installation of the tank, i.e. without it being necessary to demount and remount the tank.

A meter of this kind is described in the patent document EP 1 227 303.

In this prior art meter, the tank is of coaxial type, i.e. the outlet pipe has an elbow so as to discharge centrally on the central axis of the tank and the inlet pipe discharges through an orifice into a coaxial annular volume.

The measurement cell proposed in the above document is intended only for a tank of this type.

At present another type of tank is widely used.

This second type of tank includes an inlet pipe and an outlet pipe that are both straight and aligned with each other, discharging directly into the interior of the tank.

Mounting an ultrasound measurement cell on a tank of the second type obviously entails specially designing an appropriate measurement cell. Moreover to each type of tank there must obviously correspond a specific type of measurement cell, which increases the maintenance burden and the inventory of parts for such meters.

The invention solves this problem by proposing a capsule type ultrasound measurement cell meter including a standardized measurement cell that can be installed on a tank of the first or second type.

To this end, the invention proposes a method of mounting a capsule type ultrasound measurement cell including a measurement channel equipped with ultrasound sensors disposed in a cap and intended to be mounted on a tank including an inlet pipe and an outlet pipe of different types, said inlet pipe being intended to communicate with the inlet of said measurement channel and said outlet pipe being intended to communicate with the outlet of said measurement channel, characterized in that it consists in using an additional adapter specific to the type of tank and connecting said inlet pipe with the inlet of said measurement channel and said outlet pipe with the outlet of said measurement channel.

In a first embodiment, intended for a coaxial type tank, a first (outlet or inlet) pipe of which includes an elbow so as to discharge centrally on the central axis of the tank and a second (respectively inlet or outlet) pipe discharges into a coaxial annular volume, the adapter comprising a flared tubular part intended to be mounted on the mouth of said first pipe and to be connected in sealed fashion to said measurement cell.

The adapter preferably also comprises an intermediate ring for clamping the tank onto the measurement cell.

Said flared tubular part and said intermediate ring are advantageously formed in one piece.

In a second embodiment, intended for an aligned type tank, the inlet pipe and the outlet pipe of which are straight and aligned with each other and discharge directly into the interior of the tank, the adapter consists in an elbowed tubular part intended to be mounted on the mouth of one of said pipes and to be connected in sealed fashion to said measurement cell.

In this case, said adapter is preferably intended to be mounted on the inlet pipe.

The invention further relates to a measurement cell for implementing the above method characterized in that it includes a plate carrying said measurement channel and a clamping ring for fixing the plate to said tank, said plate including an inlet orifice and an outlet orifice, and said adapter being intended to be connected in sealed fashion to one of those orifices.

In one embodiment said plate, said measurement channel and housings intended for said sensors are in one piece.

The measurement preferably includes at least one temperature probe.

The invention further relates to a capsule assembly consisting of a measurement cell of the above kind and an adapter of the above kind assembled together.

The invention is described in more detail hereinafter with the assistance of figures showing preferred embodiments of the invention.

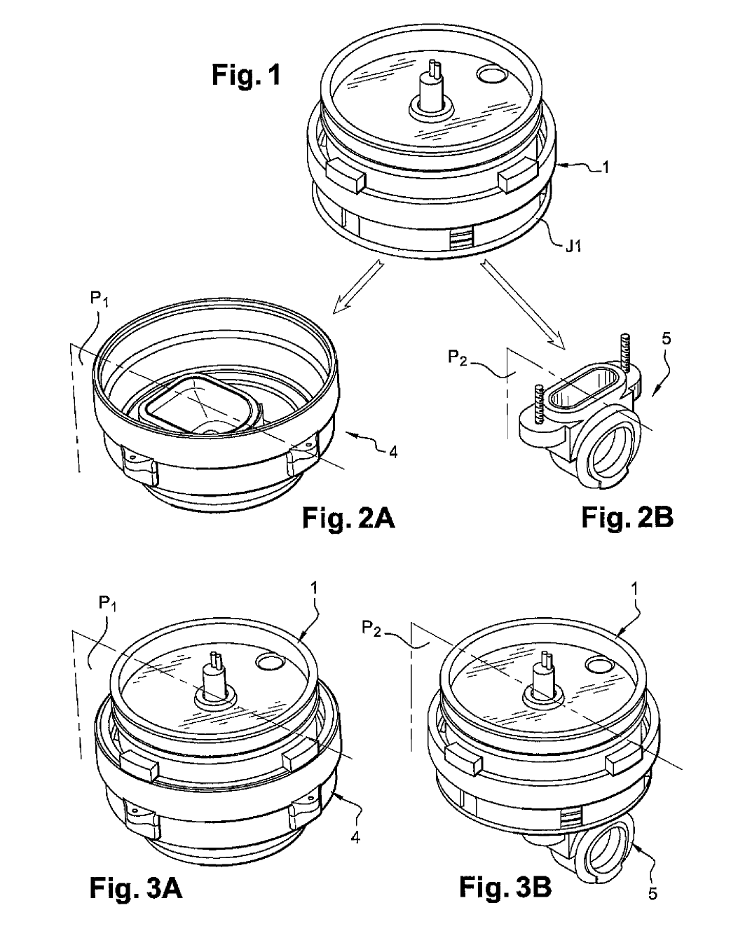

FIGS. 1, 6 and 11 are perspective views, where applicable cut away and in section on the central axis of a measurement cell of the invention.

FIGS. 2A, 7A and 12A are perspective views, where applicable cut away and in section on a plane P1, of an adapter conforming to a first embodiment of the invention.

FIGS. 2B, 7B and 12B are perspective views, where applicable cut away and in section on a plane P2, of an adapter conforming to a second embodiment of the invention.

FIGS. 3A, 8A and 13A are perspective views, where applicable cut away and in section on a plane P1, of an adapter mounted on a measurement cell conforming to the first embodiment of the invention.

FIGS. 3B, 8B and 13B are perspective views, where applicable cut away and in section on a plane P2, of an adapter mounted on a measurement cell conforming to the second embodiment of the invention.

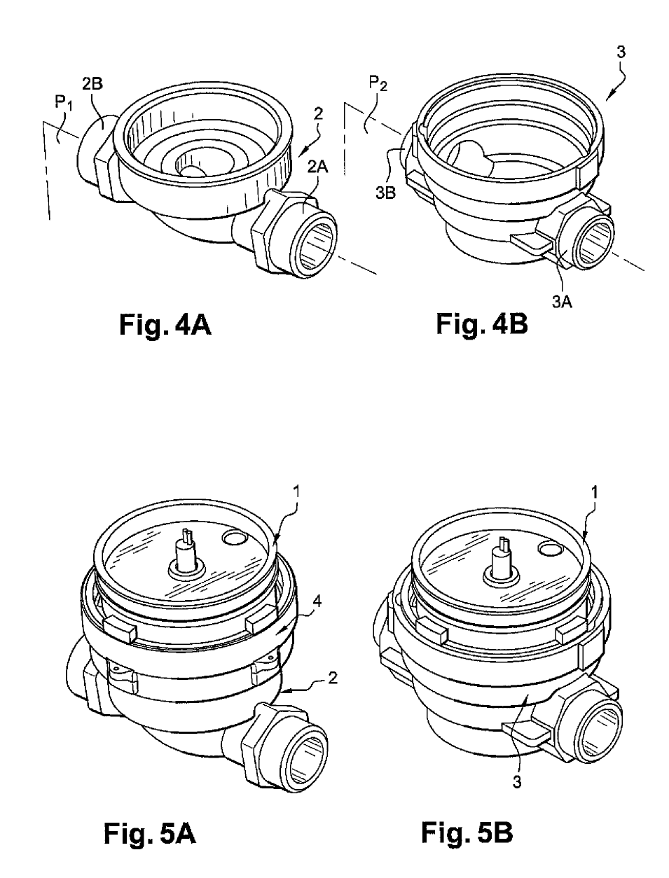

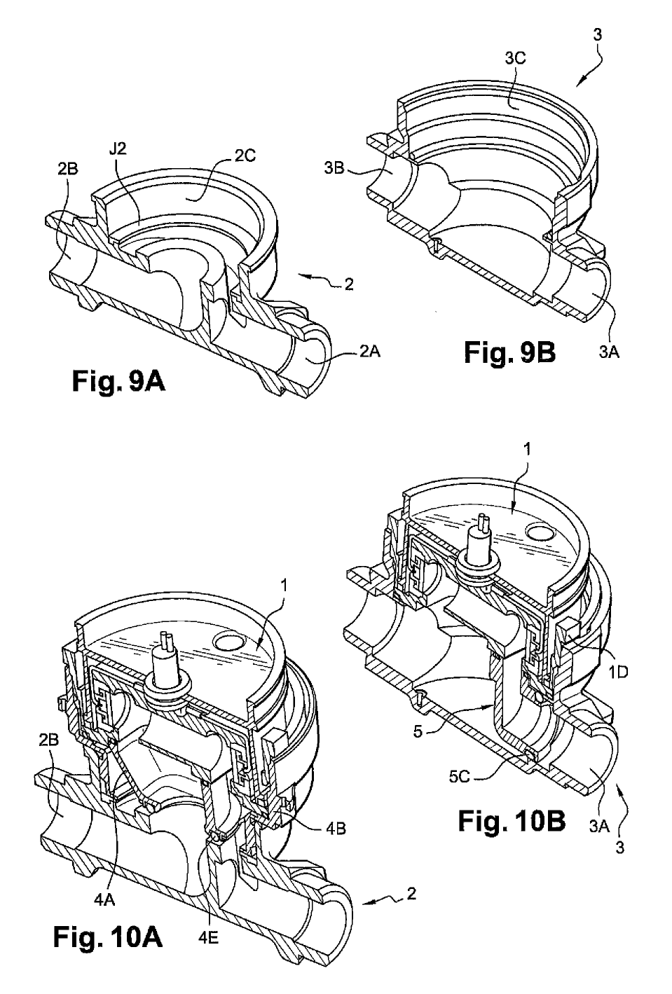

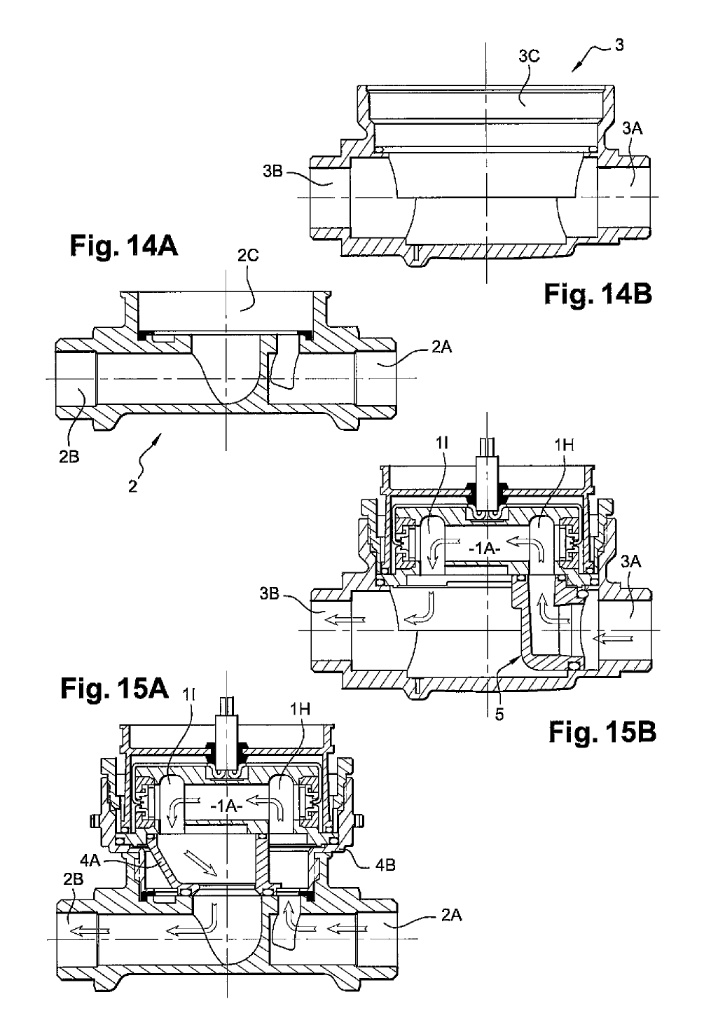

FIGS. 4A, 9A and 14A are perspective views, where applicable cut away and in section on a plane P1, of a tank conforming to the first embodiment of the invention.

FIGS. 4B, 9B and 14B are perspective views, where applicable cut away and in section on a plane P2, of a tank conforming to the second embodiment of the invention.

FIGS. 5A, 10A and 15A are perspective views, where applicable cut away and in section on a plane P1, of a meter conforming to the first embodiment of the invention.

FIGS. 5B, 10B and 15B are perspective views, where applicable cut away and in section on a plane P2, of a meter conforming to the second embodiment of the invention.

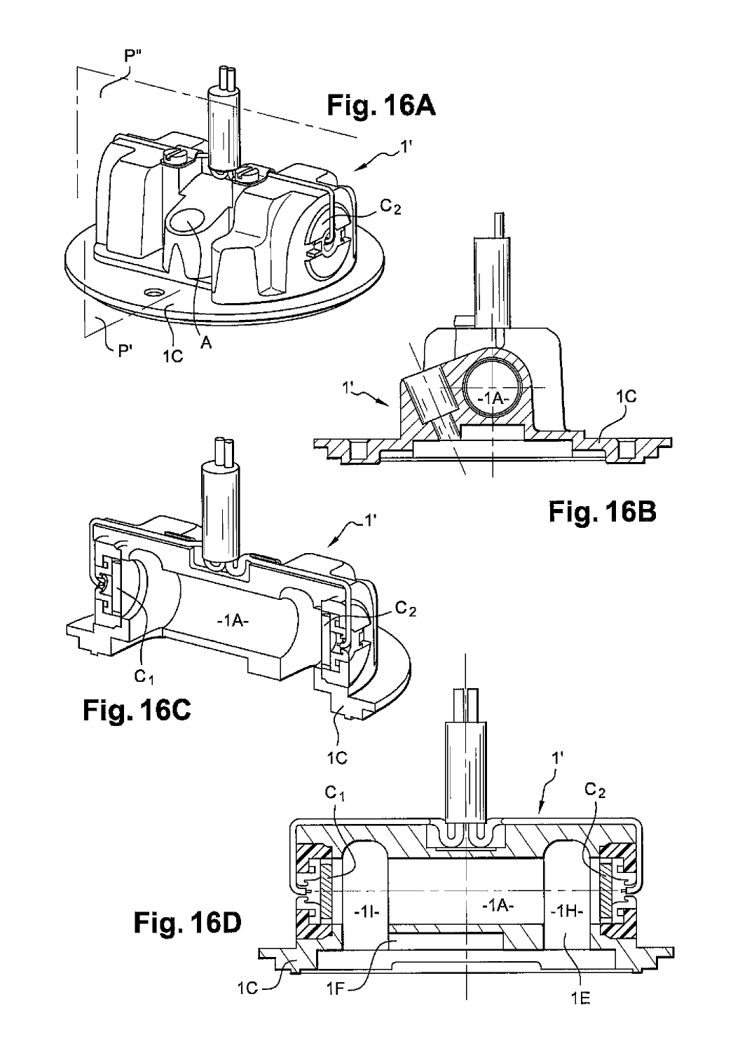

FIGS. 16A to 16D are perspective views in cross section on a plane P′ and in longitudinal section on a plane P″ of a measurement chamber according to the invention.

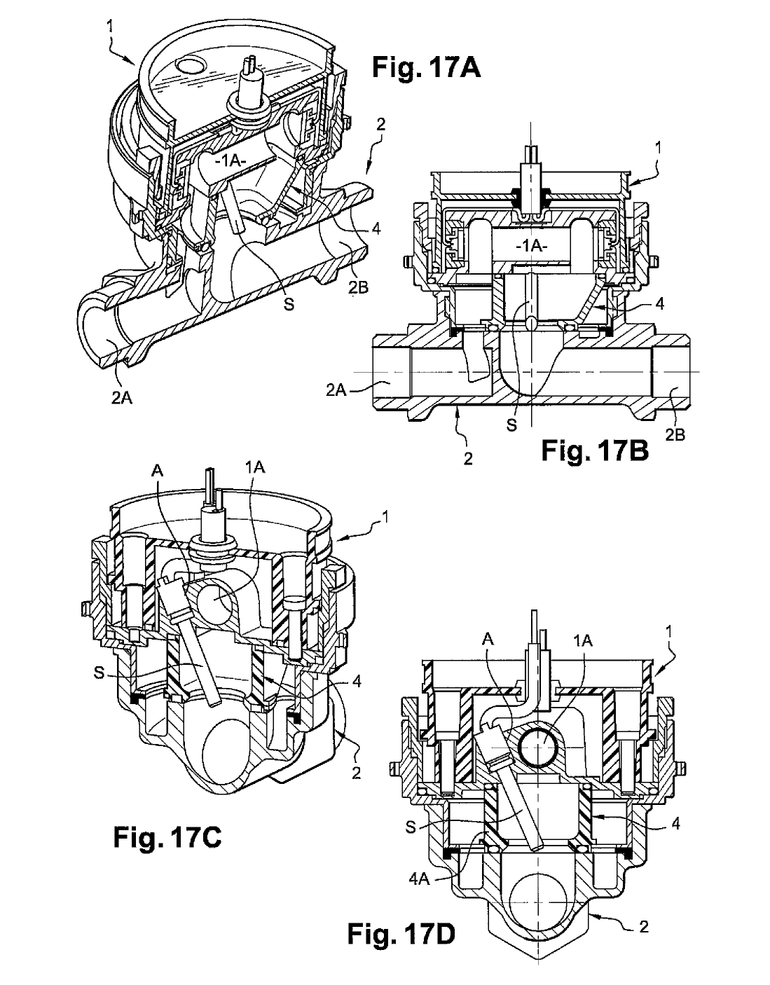

FIGS. 17A to 17D are respectively perspective views cut away on a first plane, in section on that first plane, cut away on a second plane perpendicular to the first plane and in section on that second plane of a meter conforming to the first embodiment of the invention.

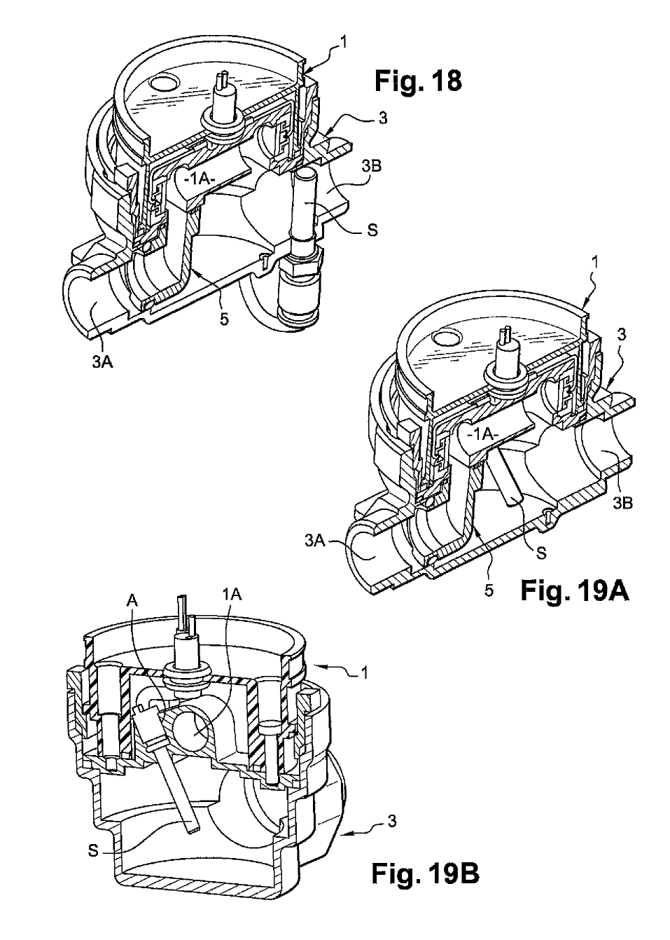

FIG. 18 is a cutaway perspective view of a meter conforming to a first variant of the second embodiment of the invention.

FIGS. 19A and 19B are perspective views cut away on two perpendicular planes of a meter conforming to a second variant of the second embodiment of the invention.

As shown in FIGS. 1 to 5, the invention standardizes an ultrasound measurement cell 1 intended to be mounted on a tank including an inlet pipe and an outlet pipe of different types.

Here FIGS. 4A and 4B show a coaxial type tank 2, i.e. in which the outlet pipe 2B incorporates an elbow so as to discharge centrally on the central axis of the tank and the inlet pipe 2A discharges through an orifice into a coaxial annular volume, and an aligned type tank 3, i.e. including an inlet pipe 3A and an outlet pipe 3B that are both straight and aligned with each other and discharge directly into the interior of the tank.

Standardization entails using an adapter connecting said inlet pipe with the inlet of said measurement channel and said outlet pipe with the outlet of said measurement channel. This adapter is connected to one of the pipes of the tank, enabling a flow of fluid in a measurement channel of the measurement cell 1.

An adapter 4 of a first type is used in the case of the coaxial type tank and another adapter 5 of a second type is used in the case of an aligned type tank.

This adapter 4, 5 is first fastened to the measurement cell to form a subassembly, referred to as the capsule, represented in FIGS. 3A and 3B, and it is this subassembly that is then connected to the corresponding tank 2, 3 to form a meter as shown in FIGS. 5A and 5B.

In the subsequent figures, the components are shown in section in more detail.

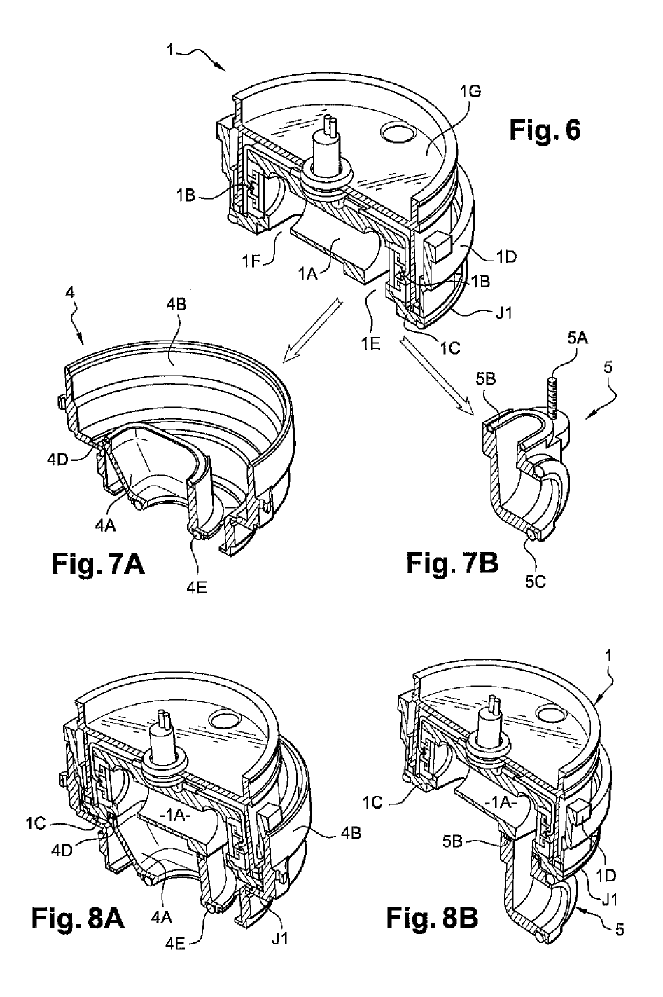

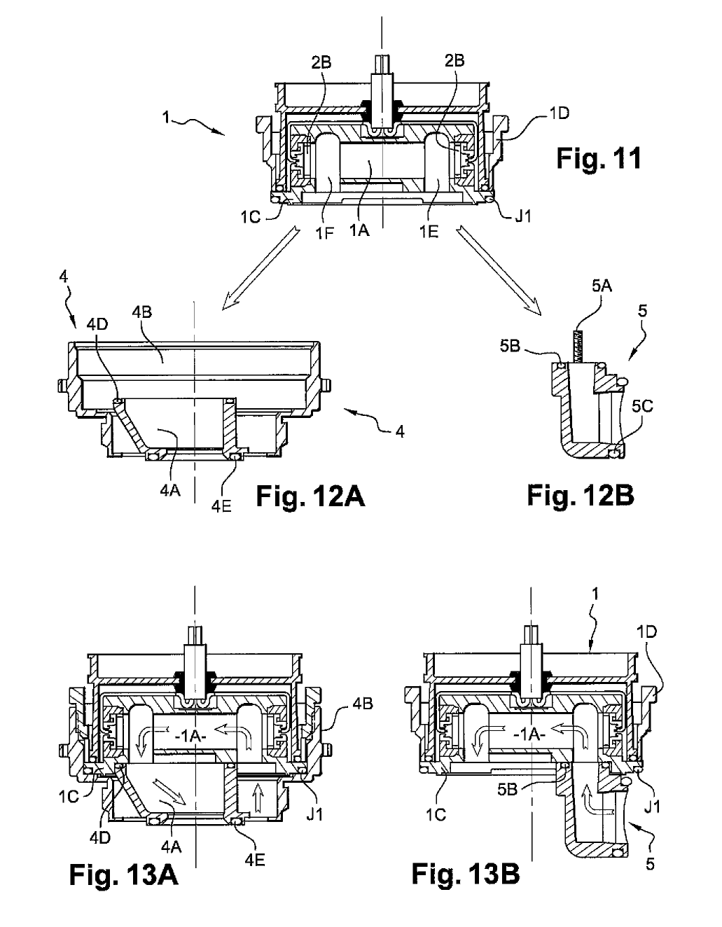

As shown in FIGS. 6 and 11, the ultrasound measurement cell 1 includes a measurement channel 1A equipped with a sender and receiver ultrasound sensor 1B at each of its ends.

It includes a plate le carrying the measurement channel and a clamping ring 1D, this plate including an inlet orifice 1E and an outlet orifice 1F, and the adapter 4 or 5 is intended to be connected in sealed fashion to one of these orifices. A protective cap 1G is placed on the top.

The inlet pipe of the tank 2A or 3A is intended to communicate with the inlet of the measurement channel corresponding to the inlet orifice 1E and the outlet pipe of the tank 2B or 3B is intended to communicate with the outlet of the measurement channel corresponding to the outlet orifice 1F. Each adapter 4 or 5 on the tank is connected to one of the pipes of the tank and enables a flow of fluid in the measurement channel 1A of the measurement cell.

Consider first mounting a measurement cell 1 on a coaxial type tank 2 as shown in FIGS. 7A, 8A, 9A, 10A, 12A, 13A, 14A and 15A.

The first type adapter 4 comprises a flared tubular part 4A intended to be mounted on the mouth of the outlet pipe 2B of the tank and to be connected in sealed fashion to the outlet orifice 1F of the measurement cell. This adapter also comprises an intermediate clamping ring 4B intended to clamp the tank 2 onto the measurement cell 1 by screwing it onto it and advantageously formed in one piece with the flared tubular part 4A.

First of all, as shown in FIG. 8A, the measurement cell 1 is fastened to the adapter 4 by screwing the intermediate ring 4B onto the clamping ring 1D provided on the measurement cell. Clamping by screwing in this way has two functions: clamping the plate 1C of the measurement cell 1 onto this intermediate ring 4B with between them a seal J1 provided on the measurement cell 1, and clamping the flared tubular part 4A against the plate 1C of the measurement cell at the periphery of the outlet orifice 1F thereof, with between them a seal 4D provided at one end of this flared tubular part 4A of the adapter 4.

Thus forming a subassembly called the capsule, the measurement cell 1 and the adapter 4 are fixed to the tank 2 by screwing the intermediate ring 4B of the adapter 4 into the inside thread 2C carried by the tank. This clamps the flared tubular part 4A by its other end left free against the periphery of the mouth of the outlet pipe 2B of the tank with between them a seal 4E provided on the adapter. This simultaneously seals the annular volume of the stream of water at tank level by virtue of the intermediate ring 4B pressing on a seal J2 carried by the tank at the bottom of its inside thread 2C.

In FIG. 15A the arrows show the flow of the fluid. It arrives through the inlet pipe 2A of the tank, into the space situated between the intermediate ring 4B and the flared tubular part 4A. It follows an admission channel 1H until it reaches the measurement channel 1A from which it is evacuated via a discharge channel 1I to the interior of the flared tubular part 4A, from which it flows into the outlet pipe 2B of the tank.

During assembly, an arrangement of markers can ensure correct relative positioning of the measurement cell 1 and the tank 2 with the axis of the inlet and outlet pipes 2A and 2B of the tank and that of the measurement channel aligned and/or the inlet orifice 1E facing the mouth of the inlet pipe 2A.

Alternatively, it is feasible for these axes not to be aligned.

Next, consider mounting a measurement cell 1 on an aligned type tank as shown in FIGS. 7B, 8B, 9B, 10B, 12B, 13B, 14B and 15B.

The second type adapter 5 consists in a tubular part with a 90° elbow intended to be mounted on the mouth of the inlet pipe 3A of the tank and to be connected in sealed fashion to the inlet orifice 1E of the plate 1C of the measurement cell.

First of all, as shown in FIG. 8B, the measurement cell 1 is fastened to the adapter 5 by tightening screws 5A in corresponding threaded bores in the measurement cell. This screw fastening clamps the adapter 5 against the plate 1C of the measurement cell at the periphery of its inlet orifice 1E, with a seal 5B at one end of the adapter 5 between them.

Thus forming a subassembly called the capsule, the measurement cell 1 and the adapter 5 are fixed to the tank 3 by screwing the clamping ring 1D of the measurement cell into the inside thread 3C carried by the tank. This clamps the adapter 5 by its other end remaining free against the periphery of the mouth of the inlet pipe 3A of the tank with between them a seal 5C provided on the adapter.

In FIG. 15B the arrows show the flow of the fluid. It arrives through the inlet pipe 3A of the tank, inside the adapter 5. It then follows the admission channel 1H until it reaches the measurement channel 1A from which it is evacuated via the discharge channel 1I into the interior of the tank 3, from which it flows into the outlet pipe 2B of the tank.

FIGS. 16A to 16D show the measurement chamber 1′ that is part of the measurement cell.

An important feature of this chamber is that the circular plate 1C, the measurement channel 1A and housings for the sensors C1, C2 are made in one piece, preferably molded in plastic material.

The longitudinal axis of the measurement channel 1A is parallel to the plate 1C. The sensors C1 and C2, which are ultrasound transducers, are disposed at the ends of the measurement channel 1A, to measure flow rate by face to face firing. The longitudinal axis of the measurement channel 1A is preferably perpendicular to the central axis of the plate 1C, in order to place this measurement channel at the center of the plate and obtain as long as possible a measurement channel within the limit set by the diameter of the plate 1C.

The ends of this measurement channel communicate with the inlet orifice 1E and the outlet orifice 1F via an admission channel 1H and a discharge channel 1I with longitudinal axes perpendicular to the axis of the measurement channel 1A. These admission and discharge channels are disposed as far as possible from the center of the measurement channel, i.e. as close as possible to the transducers C1, C2 in order to maximize the usable length for measurement of the flow rate in the path of the ultrasound.

The measurement chamber can also include a temperature measurement probe, which can be fitted into a bore A provided in the wall of the measurement chamber, for example in the case of a thermal energy meter application.

Mounting a temperature measurement probe in this way is particularly adapted to mounting on a coaxial type tank, as shown in FIGS. 17A to 17D.

The head of the probe S is fixed into the bore A situated laterally with respect to the measurement channel 1A so that its measurement end is at the core of the outlet flow on the central axis of the meter in the vicinity of the end of the flared tubular part 4A of the adapter 4 clamped against the tank 4.

In the case of mounting the measurement cell 1 on an aligned type tank 3, a temperature measurement probe S can also be mounted in the manner shown in FIGS. 18, 19A and 19B.

This probe S can be mounted inclined in the bore A, as before, and as shown in FIGS. 19A and 19B. Its measurement end is then at the core of the outlet flow inside the tank 3.

Alternatively, the probe S can be mounted in the outlet pipe of the tank as shown in FIG. 18.

The embodiment described hereinabove is a preferred embodiment. The invention also concerns different embodiments that are not specifically described.

For example, the inlet pipe and the outlet pipe of each tank can be interchanged. For example, in the case of a coaxial type tank, the central pipe can be an inlet pipe and the annular pipe can be an outlet pipe.

1-10. (canceled)

11. Method of mounting a capsule type ultrasound measurement cell including a measurement channel equipped with ultrasound sensors disposed in a cap and intended to be mounted on a tank including an inlet pipe and an outlet pipe of different types, said inlet pipe being intended to communicate with the inlet of said measurement channel and said outlet pipe being intended to communicate with the outlet of said measurement channel, characterized in that it consists in using an additional adapter specific to the type of tank and connecting said inlet pipe with the inlet of said measurement channel and said outlet pipe with the outlet of said measurement channel.

12. Adapter for implementing the method according to claim 11, intended for a coaxial type tank, a first (outlet or inlet) pipe of which includes an elbow so as to discharge centrally on the central axis of the tank and a second (respectively inlet or outlet) pipe discharges into a coaxial annular volume, characterized in that it comprises a flared tubular part intended to be mounted on the mouth of said first pipe and to be connected in sealed fashion to said measurement cell.

13. Adapter according to claim 12, characterized in that it also comprises an intermediate ring for clamping the tank onto the measurement cell.

14. Adapter according to claim 13, characterized in that said flared tubular part and said intermediate ring are formed in one piece.

15. Adapter for implementing the method according to claim 11, intended for an aligned type tank, the inlet pipe and the outlet pipe of which are straight and aligned with each other and discharge directly into the interior of the tank, characterized in that it consists in an elbowed tubular part intended to be mounted on the mouth of one of said pipes and to be connected in sealed fashion to said measurement cell.

16. Adapter according to claim 15, characterized in that said adapter is intended to be mounted on the inlet pipe.

17. Measurement cell for implementing the method according to claim 11, characterized in that it includes a plate carrying said measurement channel and a clamping ring, said plate including an inlet orifice and an outlet orifice, and said adapter being intended to be connected in sealed fashion to one of those orifices.

18. Measurement cell according to claim 17, characterized in that said plate, said measurement channel and housings intended for said sensors are in one piece.

19. Measurement cell according to claim 17, further including at least one temperature probe.

20. Capsule assembly consisting of an adapter according to claim 12, and assembled together with a measurement cell including a plate carrying a measurement channel and a clamping ring, said plate including an inlet orifice and an outlet orifice, and said adapter being adapter for sealed connection with at least one of said orifices.
